(19) United States
(12) Patent Application Publication
(10) Pub. No.: US 2003/0192215 A1
(43) Pub. Date: Oct. 16, 2003

(54) Pedal cycle decoration panel with animation display

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/121,696

(22) Filed: Apr. 15, 2002

(51) Int. Cl. G09F 19/00

(52) U.S. Cl. 40/482

(57) ABSTRACT

A decoration panel with animation effects mounted to a pedal cycle comprises a panel, a linkage cable and a transmission mechanism adapted to a frame including a wheel and an axial of he pedal cycle; the panel being inserted with a pattern board showing a pattern on a display window in front of the panel; a cable core of the linkage cable having its upper end fixed to the pattern board; the transmission mechanism including a pin driven by a cam or an eccentric characterized by that: said cam or eccentric being linked to a reduction gear or an intermittent reduction gear connected to the axial of the wheel to cause the pattern board to change at slow motion or have a static 3D display.

### BACKGROUND OF THE INVENTION

(a) Field of the Invention

The present invention relates to a decoration panel with animation display mounted to a pedal cycle, and more particularly, to one that provided animation display simultaneously as the cycle advances for visual effects of speed variable or static display of animation to add more fin of riding.

(b) Description of the Prior Art

Most of the pedal cycles including tricycle for children, scooter, shopping cart with child seat, stationary bicycle and bicycle generally available in the market feature monotonous frame structure with variation to its best in configuration and color of the primary structure of the frame, or certain decoration items adapted to the handle to attract the children and to add more fun to the riding. However, the structure of the prior art is plain without creativity, and dull without any change in visual impression to discourage a consumer for a buy. On the other hand, even provided with a decoration panel for animation display, some of the patterns require fast changing pace while the others need slow changing pace. The present invention is designed for patterns requiring slow changing pace and even for instantaneous creation of static visual effects.

### SUMMARY OF THE INVENTION

The primary purpose of the present invention is to provide a decoration panel with animation effects for a pedal cycle comprising a panel, a linkage cable and a transmission mechanism adapted to a frame including a wheel and an axial of the pedal cycle; the panel being inserted with a pattern board showing the pattern on a display window in front of the panel; a cable core of the linkage cable having its upper end fixed to the pattern board; the transmission mechanism including a pin driven by a cam or an eccentric characterized by that said cam or eccentric being linked to a reduction gear or an intermittent reduction gear connected to the axial of the wheel to cause the pattern board to change at slow motion or have a static 3D display.

### BRIEF DESCRIPTION OF THE DRAWINGS

FIG. 1 is a perspective view of the present invention.

FIG. 2 is a cross sectional view of a wheel of the present invention.

FIG. 3 is a longitudinal sectional view of a first preferred embodiment of the present invention adapted with a cam.

FIG. 4 is a longitudinal sectional view of a second preferred embodiment of the present invention adapted with an eccentric.

FIG. 5 is a longitudinal sectional view of a third preferred embodiment of the present invention adapted with a reduction gear.

FIG. 6 is a longitudinal sectional view of a fourth preferred embodiment of the present invention adapted with an intermittent reduction gear.

### DETAILED DESCRIPTION OF THE PREFERRED EMBODIMENTS

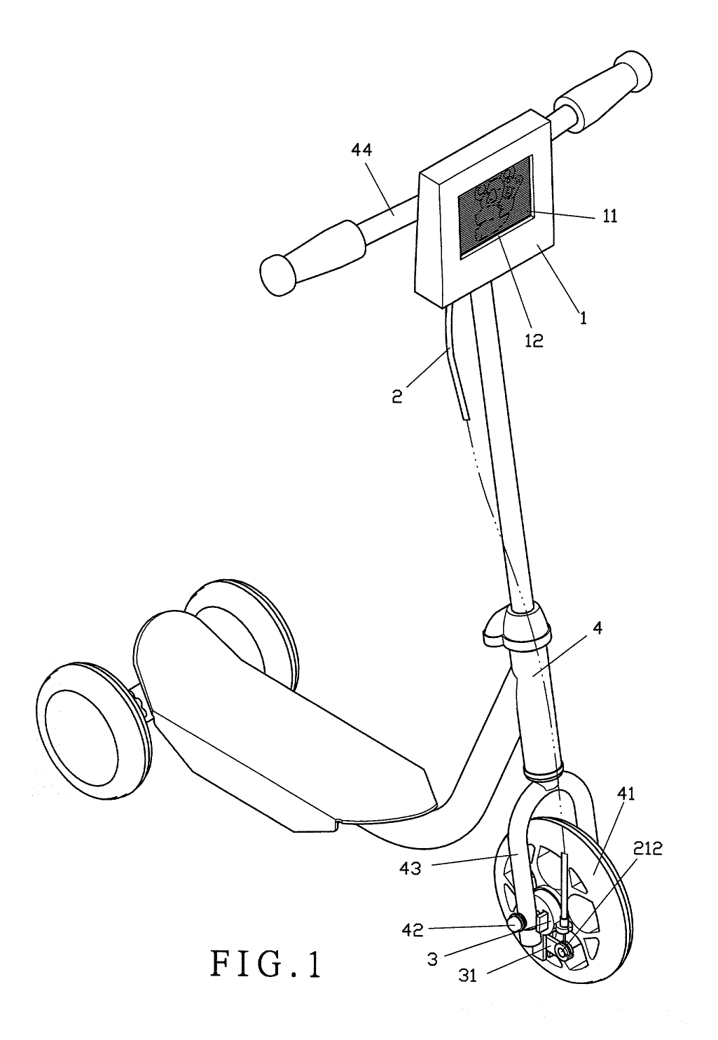

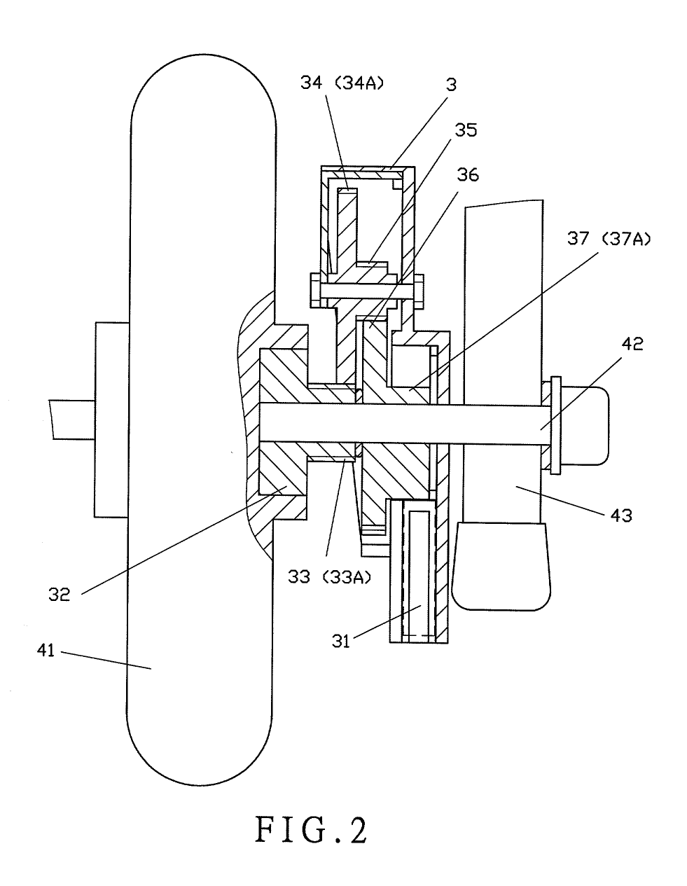

Referring to FIGS. 1 and 2, a preferred embodiment of the present invention comprises a panel (1), a linkage cable (2) and a transmission mechanism (3) adapted to a frame (4) of a pedal cycle; the frame (4) including a wheel (41) and a fork (43) engaged to an axial (42).

The panel (1) provided at where close to a handle (44) of the frame (4) is a painting frame inserted inside a pattern board (11); a display window (12) in front of the panel (1) to expose a pattern on the pattern board (11); a fixation bit (111) bent into an “L” shape extending from the bottom of the pattern board (11); and a conduit (13) extending also from the bottom of the panel (1) inserted in a spring (14) before being inserted into the fixation bit (111) for the pattern board (11) to slide up and down as guided along the conduit (13) and to return to its home point, thus to cause the portion of the pattern visible in the display window (12) to change; i.e., the pattern changes its presentation to a viewer.

The linkage cable (2) in the similar structure of a braking cable adapted to a bicycle, is a cable core (21) inserted into a sheath having an upper end (211) of the core (21) to pass through the conduit (13) and secured to the fixation bit (11) while a lower end (212) of the core (21) being secured to a pin (31) to be described later, since the lower end (212) of the core (21) being driven by the pin (31) linked to it; the pattern board (11) for being linked to the lower end (212) of the core (21) becomes movable.

The transmission mechanism (3) is a box fixed to the fork (43) of the frame (4) of the pedal cycle further comprising the pin (31), a transmission shaft (32), a primary active gear (33) or an intermittent active gear (33A), a primary passive gear (34) or an intermittent passive gear (34A), a terminal active gear (35), a terminal passive gear (36), and a cam (37) or an eccentric (37A), wherein, a reduction gear set as the primary characteristic of the present invention is composed of the primary active gear (33) and the primary passive gear (34) constitute; and an intermittent reduction gear set as the secondary characteristic of the present invention is formed by the intermitted active gear (33A) and the intermittent passive gear (34A).

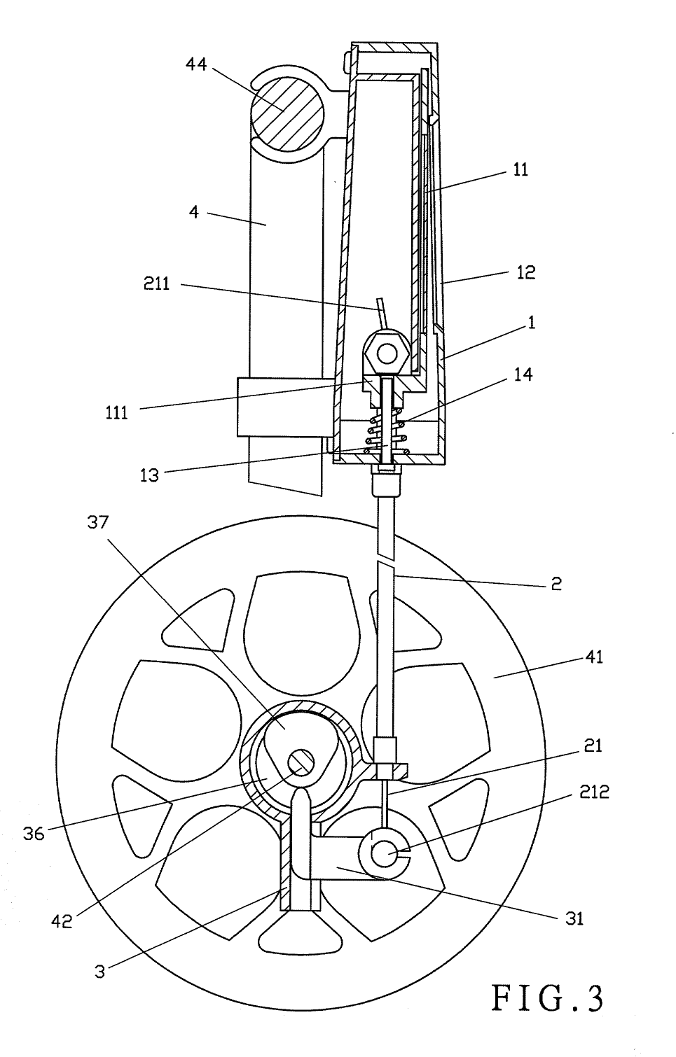

As for the combination of the transmission mechanism (3) and other members is that the transmission shaft (32) being linked to the axial (42) of the wheel (41) for motion; the transmission shaft (32) being engaged to the primary active gear (33) or the intermittent active gear (33A), the primary active gear (33) being engaged to the primary passive gear (34) or the intermittent passive gear (34A) for reduction purpose while the primary passive gear (34) or the intermittent passive gear (34) being respectively to be co-axially secured with the terminal active gear (35); the terminal active gear (35) being engaged to the terminal passive gear (36) which in turn being respectively secured co-axially with the cam (37) or the eccentric (37A), furthermore, the cam (37) or the eccentric (37A) having its edge to hold against a tip of the pin (31); and the pin (31) having its lower portion bent into an “L” shape to be secured to the lower end (212) of the cable core (21) of the linkage cable (2). Accordingly, as illustrated in FIG. 3, once the cam (37) turns, it holds against the pin (31) to move downward to drive the lower end (212) of the cable core (21), the pattern board (11) linked to the upper end (211) of the cable core (21) slides up and down in a variable speed due to the geometric shape of the cam (37).

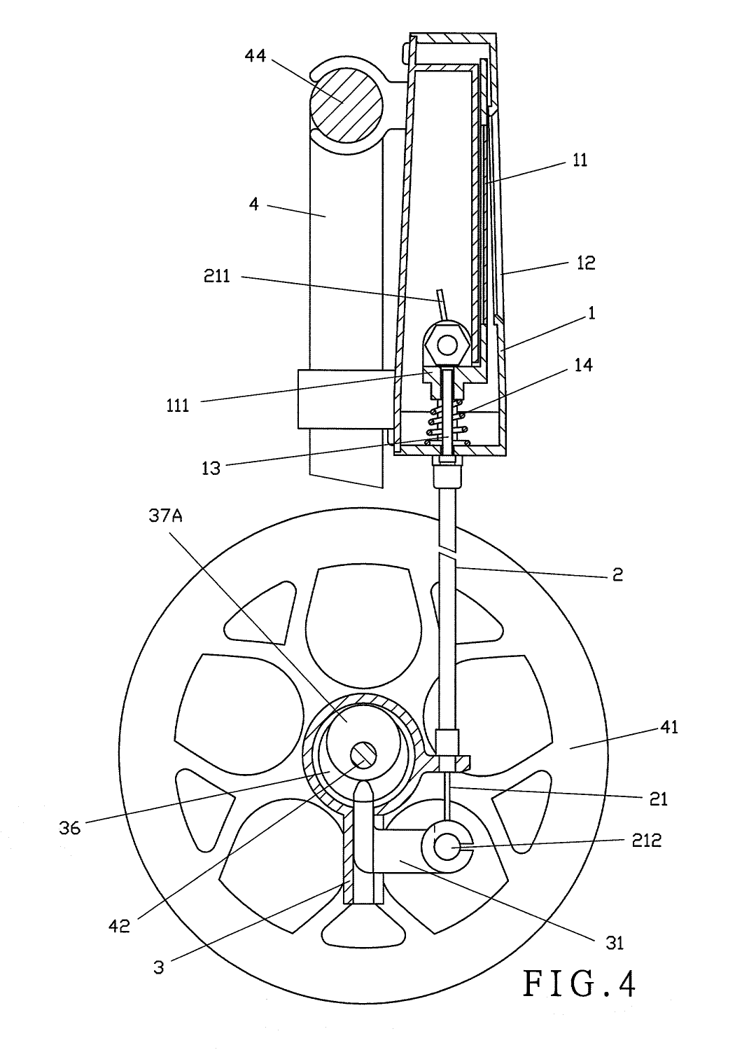

Now referring to FIG. 4, the cam (37) in FIG. 3 is replaced by the eccentric (37A) so that as the eccentric (37A) turns, it holds against the pin (31) linked to the lower end (212) of the cable core (21) to move downward for the pattern board (11) linked to the upper end (211) of the core (21) in a variable speed due to the geometric shape of the eccentric (37A).

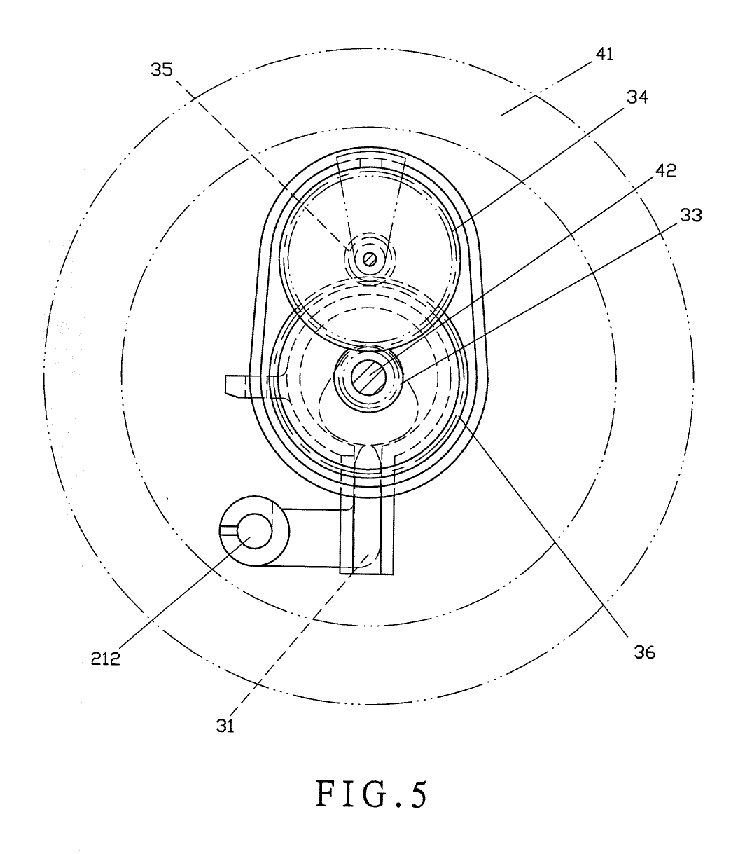

FIG. 5 shows the motion of the reduction gear set as the primary characteristic of the present invention. The primary active gear (33) engaging the primary passive gear (34) executes continuous motion and to achieve reduction due to tooth ratio between both of the primary passive gem (33) and the primary passive gear (34) to lead the pattern on the pattern board (11) exposed in the display window (12) to change its presentation at slow motion for a rider on the pedal cycle to watch the changing pattern at slow motion no matter how fast he may ride at that time.

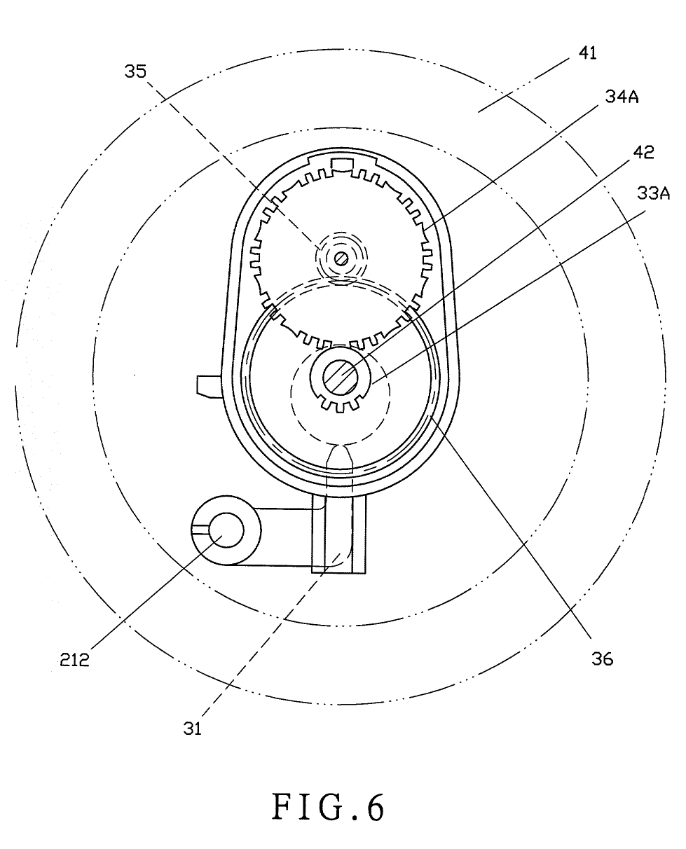

As illustrated in FIG. 6 for the motion of the reduction gear set as the secondary characteristic of the present invention. The intermittent active gear (33A) is engaged to the intermittent passive gear (34A) and for each full turn of the intermittent active gear (33A) only drives the intermittent passive gear (34A) to turn for a limited section since there are only three teeth provided to the intermittent active gear (33A); and when the teeth of the intermittent active gear (33A) engaging those from the intermittent passive gear (34A), the intermittent active gear (33A) in fact never stay apart from the intermittent passive gear (34A) as both contact each other by sliding. Therefore, during the absence for the teeth of the intermittent active gear (33A) being engaged to the intermittent passive gear (34A), the later is not driven by the former; and the pattern on the pattern board (11) exposed in the display window (12) creates the visual effects of being frozen.

As disclosed, the pattern on the pattern board (11) of the present invention is exposed and moving up and down in the display window (12) depending on the various speeds required by the individual topic of the animation to indicate reduced speed to slow motion or frozen visual effect, further to create optimal animation effect for the pedal cycle be it a bicycle, tricycle, scooter, shopping art or a stationary bicycle.

I claim:

1. A decoration panel with animation effects for a pedal cycle, comprising a panel, a linkage cable and a transmission mechanism adapted to a frame including a wheel and an axial of the pedal cycle; the panel being inserted with a pattern board showing a pattern on a display window in front of the panel; a cable core of the linkage cable having its upper end fixed to the pattern board and its lower end fixed to a pin of the transmission mechanism, the pin being driven by a cam or an eccentric characterized by that:
in the transmission mechanism, a gear reduction gear set being composed of a primary active gear and a primary passive gear; and the cam or the eccentric being linked for motion to a reduction gear set connected to the axial of the wheel for the pattern on the pattern board to present visual effects of animation at slow motion.

2. A decoration panel with animation effects for a pedal cycle as claimed in claim 1, wherein, a gear reduction set provided in the transmission mechanism is composed of an intermittent active gear and an intermittent passive gear and the cam or the eccentric being linked for motion to a reduction gear set connected to the axial of the wheel for the pattern on the pattern board to present visual effects that the pattern is frozen.
